(19) United States
(12) Patent Application Publication
(10) Pub. No.: US 2015/0151310 A1
(43) Pub. Date: Jun. 4, 2015

(54) SPRAY HEAD

(71) Applicant: Multishower GB Ltd, Kilalloo (GB)

(72) Inventors: Christie Allen, Kilalloo (GB); James Clarke, Strabane (GB)

(21) Appl. No.: 14/403,395

(22) PCT Filed: May 23, 2013
(86) PCT No.: PCT/EP2013/060674

§ 371 Date: Nov. 24, 2014

(30) Foreign Application Priority Data
May 25, 2012 (GB) 1209199.7

(51) Int. Cl. B05B 1/18; B05B 1/26

(52) U.S. Cl. CPC B05B 1/185; B05B 1/265

(57) ABSTRACT

A spray head comprising a body having a flow passage therethrough, said flow passage having an outlet opening, a mouthpiece being mounted on said body, said mouthpiece having a wall portion defining a through channel communicating with said flow passage, a deflector element being provided comprising a head portion located centrally within said through channel of the mouthpiece to define a flow path between said head portion of the deflector element and said wall portion of the mouthpiece and an elongate stem extending inwardly from the head portion into said flow passage of the body to define a flow restriction within said flow passage, characterised in that the deflector element is supported within the through channel of the mouthpiece by at least one elongate rib or leg extending between said wall portion of the mouthpiece or a wall portion of the flow passage and a portion of the deflector element.

The present invention relates to a spray head and in particular to a spray head for a shower or garden hose.

A spray head, often referred to as a shower head when used in a shower, typically comprises a body having a flow passage for the passage of water communicating with an opening to which is attached an apertured plate or rose for providing a dispersed spray of water therefrom. EP 0 776 251 discloses a shower head having reduced water consumption compared to such typical shower head, wherein a single substantially central outlet passage incorporates a rotationally symmetrical deflector element having a stem extending into a flow passage of the shower head and a head located in said outlet passage. Whilst such arrangement has a lower water consumption that traditional shower heads, the numerous small and complex shaped components comprising the shower head leads to increased manufacturing and assembly costs. In particular, it is difficult to ensure that the head of the deflector element is mounted centrally within the outlet passage of the spray head, leading to creation of an uneven spray pattern. Furthermore, the arrangement of the components of the shower head shown in EP 0 776 251 causes problems in relation to cleaning. There is a concern that shower heads may be a breeding ground for Mycobacterium that are known to cause respiratory infections.

According to a first aspect of the present invention there is provided a spray head as claimed in claim 1.

In a further aspect, the present invention provides a shower assembly comprising a spray head in accordance with said first aspect of the present invention.

Preferred features of the invention are defined in the dependent claims.

Preferred embodiments of the present invention will now be described, by way of example only, with reference to the accompanying drawings, in which:—

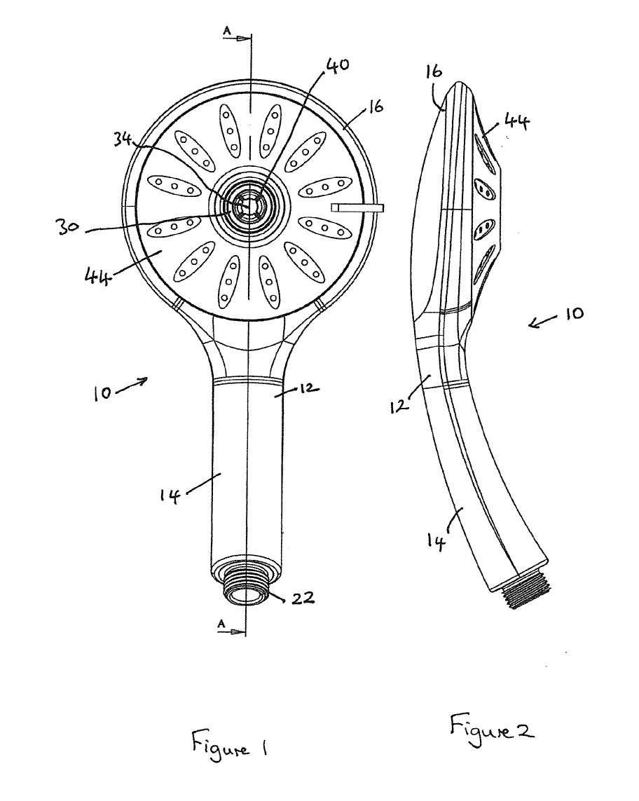

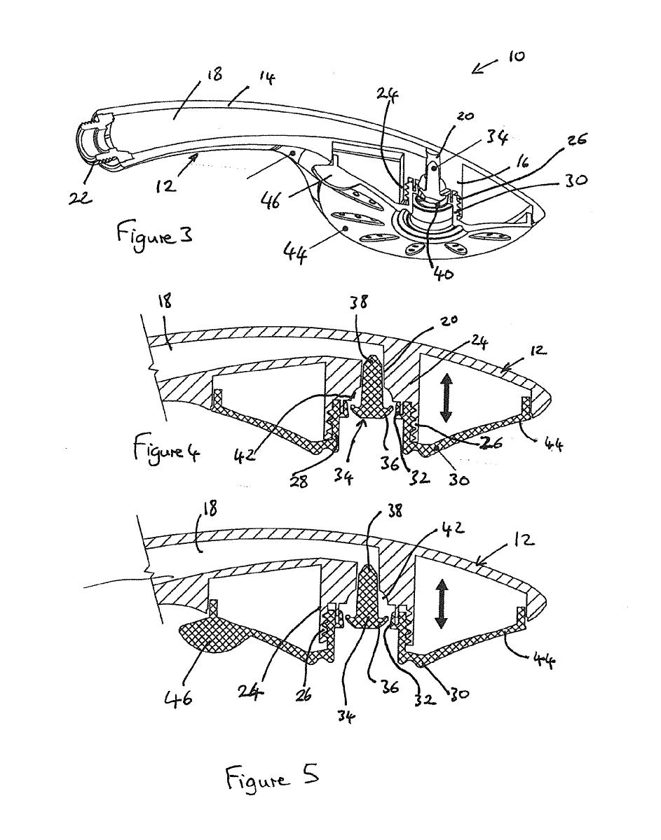

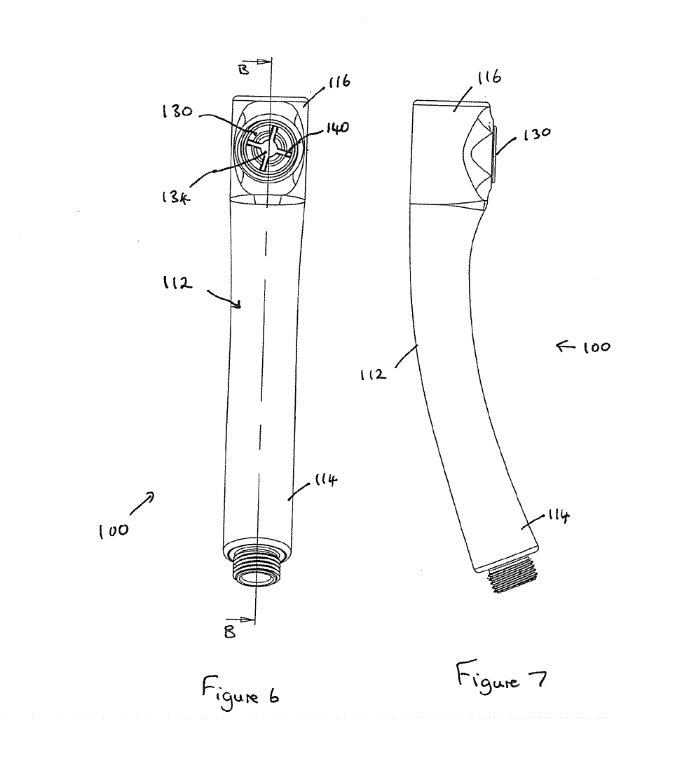

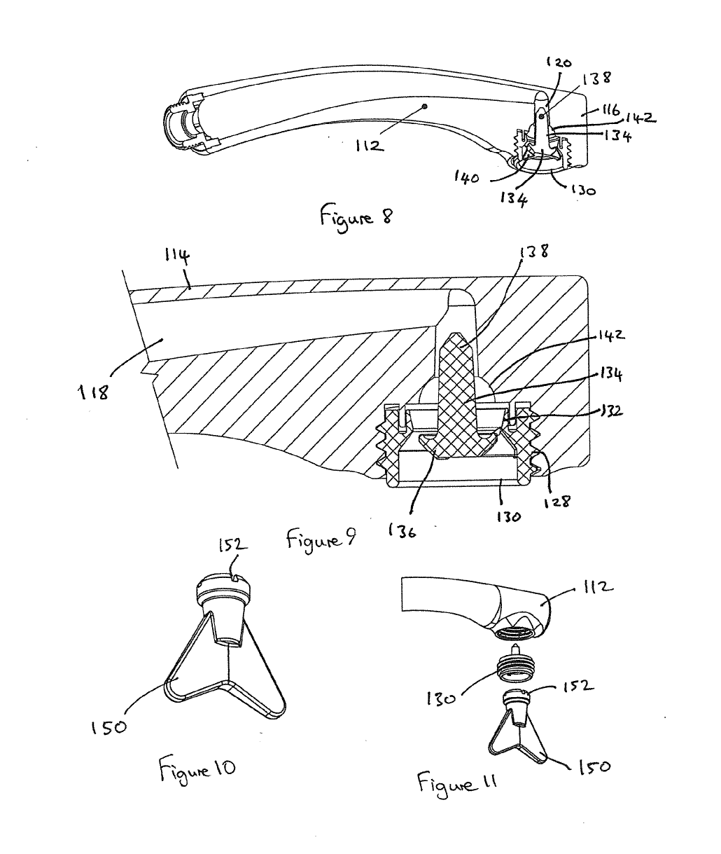

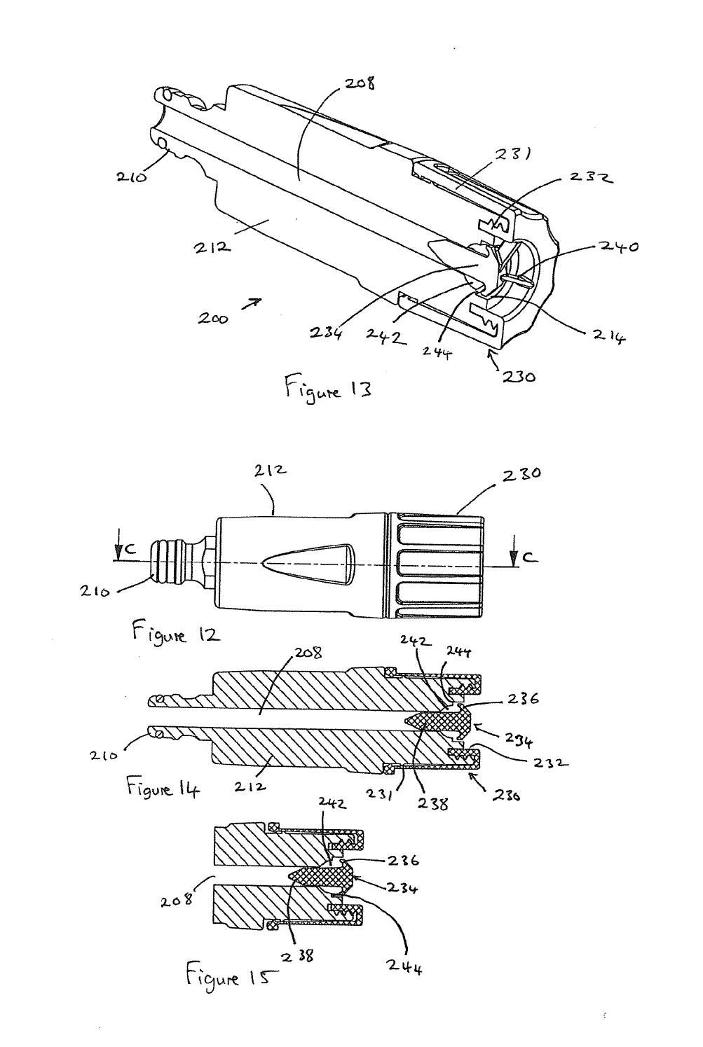

FIG. 1 is a face view of a spray head in accordance with a first embodiment of the present invention;

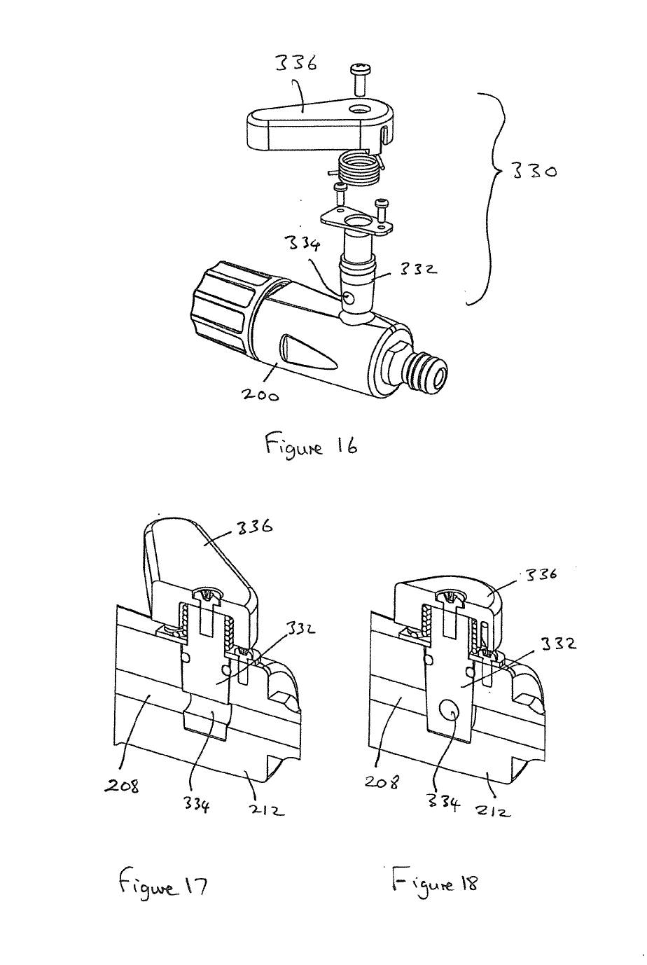

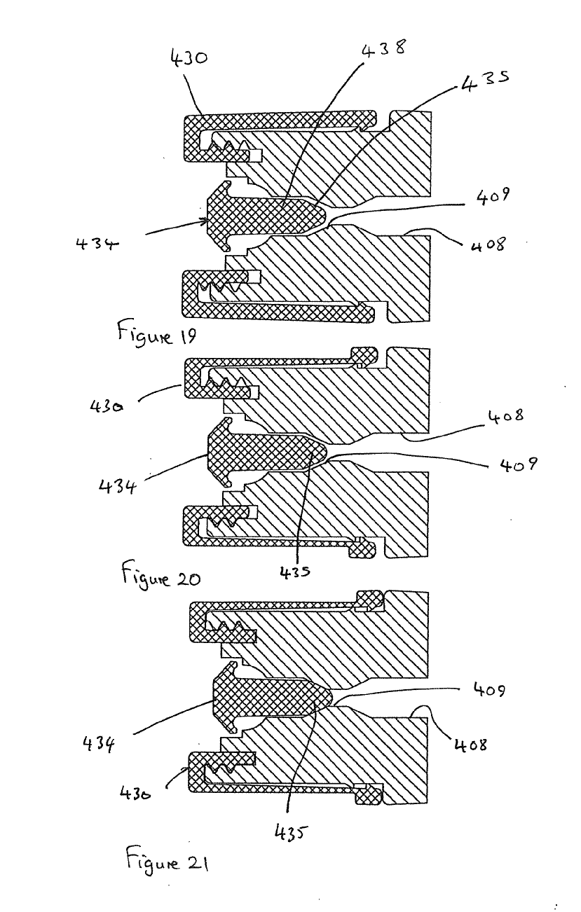

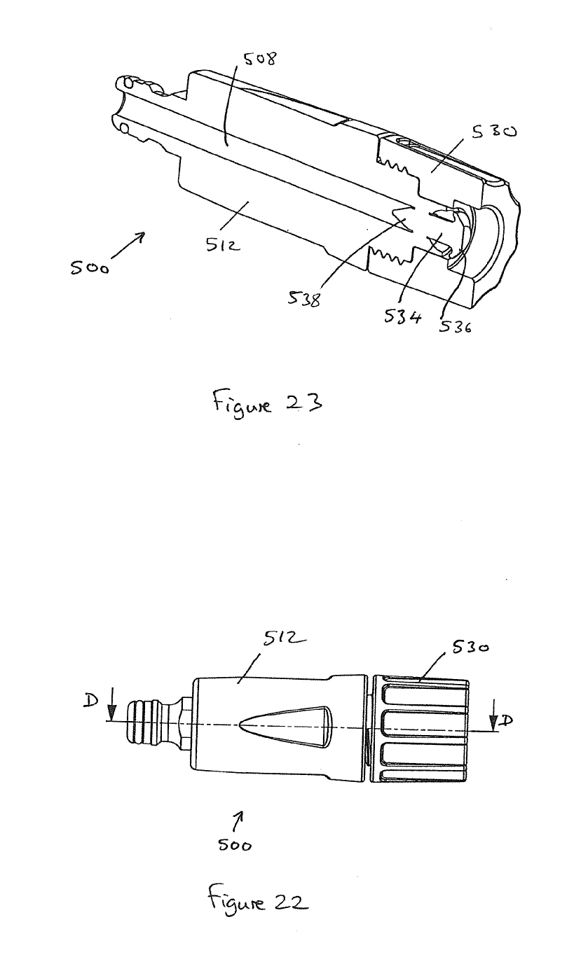

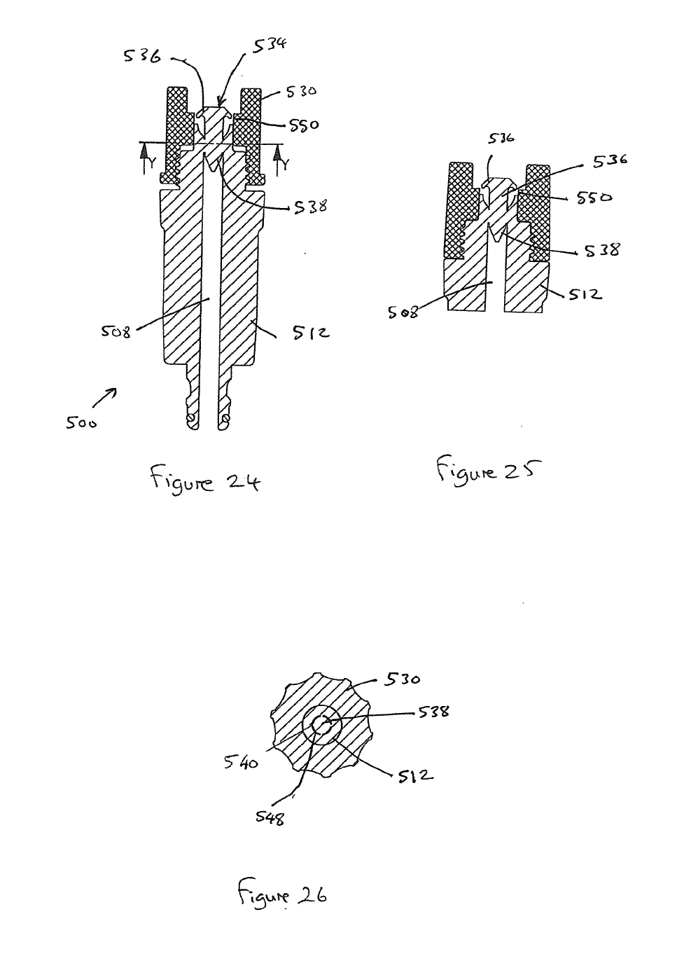

FIG. 2 is a side view of the spray head of FIG. 1;

FIG. 3 is a perspective sectional view of the spray head of FIG. 1 on line A-A of FIG. 1;

FIG. 4 is a detailed sectional view of the spray head of FIG. 1 showing the mouthpiece in a first position relative to the body of the spray head;

FIG. 5 is a detailed perspective view of the spray head of FIG. 1 showing the mouthpiece in a second position relative to the body of the spray head;

FIG. 6 is a face view of a spray head in accordance with a second embodiment of the present invention;

FIG. 7 is a side view of the spray head of FIG. 6;

FIG. 8 is a perspective sectional view of the spray head of FIG. 6 on line B-B of FIG. 6;

FIG. 9 is a detailed sectional view of the spray head of FIG. 6;

FIG. 10 is a perspective view of a tool for use with the spray head of FIG. 9;

FIG. 11 is an exploded view of the tool of FIG. 10 in use;

FIG. 12 is a side view of a spray head in accordance with a further embodiment of the present invention;

FIG. 13 is a perspective sectional view of the spray head of FIG. 12 on line C-C of FIG. 10;

FIG. 14 is a further sectional view of the spray head of FIG. 12 on line C-C;

FIG. 15 is a detailed sectional view of the spray head of FIG. 12 showing the mouthpiece in a 10 second position relative to the body of the spray head;

FIG. 16 is an exploded perspective view of a modified spray head in accordance with a further embodiment of the present invention incorporating a shut off valve;

FIG. 17 is a part sectional view of the spray head of FIG. 16 showing the shut off valve in an open position;

FIG. 18 is a part sectional view of the spray head of FIG. 16 showing the shut off valve in a closed position;

FIG. 19 is a part sectional view of a spray in accordance with a further embodiment of the present invention;

FIG. 20 is a part sectional view of the spray head of FIG. 19 showing the mouthpiece in a second position relative to the body of the spray head;

FIG. 21 is a part sectional view of the spray head of FIG. 17 showing the mouthpiece in a third position relative to the body of the spray head;

FIG. 22 is a side view of a spray head in accordance with a further embodiment of the present invention;

FIG. 23 is a perspective sectional view of the spray head of FIG. 22 on line D-D;

FIG. 24 is a sectional view of the spray head of FIG. 22 on line D-D showing the mouthpiece in a first position relative to the body of the spray head;

FIG. 25 is a sectional view of the spray head of FIG. 22 on line D-D showing the mouthpiece in a second position relative to the body of the spray head; and

FIG. 26 is a sectional view of the spray head of FIG. 22 on line Y-Y of FIG. 24.

A spray head 10 for a shower (or shower head) in accordance with a first embodiment of the present is illustrated in FIGS. 1 to 5. The spray head 10 comprises a moulded plastic body 12 defining a handle portion 14 and a head portion 16. A flow passage extends through the body, a first section 18 of the low passage extending through the handle portion 14 and a second section 20 extending from a distal end of the first section 16 to an outlet region 42 of the flow passage of the body 12, the second section 20 extending substantially perpendicular to the first section 18.

The first section 18 of the flow passage tapers inwardly from an inlet end towards the second section 20, such that the internal diameter of said first section 18 gradually reduces towards the second section 20. An inlet end of the first section 18 of the flow passage is associated with a male threaded fitting 22 provided at an end of the handle portion 14 for attachment to a treaded end fitting of a water supply hose of a shower assembly (not shown) for supplying water to the spray head, as is conventional in the art.

The second section 20 of the flow passage terminates in an outlet opening defined by a cylindrical body 24 within a central region of the head portion 16. An outer end of said cylindrical body 24 is provided with a female thread 26 adapted to receive a corresponding threaded portion 28 of a mouthpiece 30.

The mouthpiece 30 includes an annular wall portion 32 centrally located within said threaded portion 28, said wall portion 32 defining an annular through channel. A deflector element 34 is integrally formed with the mouthpiece 30, said deflector element 34 comprising a head 36 centrally located within said annular through channel and an inwardly extending stem 38 arranged to extend into the second section 20 of the flow passage when the mouthpiece 30 is attached to the body 12 of the spray head 10, as best shown in FIGS. 3 to 5, such that a flow restriction is defined between the inner wall of the flow passage and the outer wall of the stem 38.

The deflector element 34 is mounted within the through channel of the mouthpiece 30 by a plurality of equi-spaced legs 40 extending between the annular wall portion 32 of the mouthpiece 30 and the head 36 of the deflector element 34. This ensures that the deflector element is centrally located within the mouthpiece. The mouthpiece 30 and deflector element 34 may be integrally formed as a single component. Such component may be formed from a plastic material and may be formed by an injection moulding process. The plastic material forming the mouthpiece and/or the body of the spray head may incorporate a material having anti-microbial properties, such as those marketed by Biomaster Antimicrobial Technology.

The deflector element 34 comprises a rotationally symmetrical body. The underside of the head 36 of the deflector element 34 defines a dish shaped surface facing the outlet region 42 of the flow passage.

The walls of the outlet region 42 of the flow passage comprise a conical surface converging axially outwardly and terminating in a substantially cylindrical surface to define a bowl shaped region 42 directly upstream of the head 36 of the deflector element 34.

The axial distance between the head 36 of the deflector element 34 and the outlet region 42 of the flow passage can be adjusted by rotating the mouthpiece 30 with respect to the body 12 of the spray head 10 to adjust the spray characteristics of water leaving the spray head via the flow path between the deflector element 34 and the surrounding annular wall portion 32 of the mouthpiece 30.

The spray head 10 of FIGS. 1 to 5 provides the same benefits of low water consumption and desirable spray characteristics as that of EP 0 776 251, while only requiring two separate components (i.e. the body 12 and mouthpiece 30) that can be easily assembled and easily dismantled for cleaning purposes. By forming the deflector element 34 integrally with the mouthpiece 30, adjustment of the spray characteristics of the spray head 10 is facilitated while removal of the deflector element 34 for cleaning is greatly simplified. Furthermore, by mounting the deflector element within the mouthpiece by means of equi-spaced legs, the centralisation of the deflector element within the mouthpiece and flow passage is assured.

In the embodiment shown in FIGS. 1 to 5, a peripheral region 44 of the mouthpiece 30 is shaped to replicate the rose of a standard shower head, although, unlike a known rose, such region 44 is devoid of outlet apertures, avoiding the cleaning problems associated with known shower heads. An adjusting lever 46 is provided on said peripheral region 44 of the mouthpiece 30 to allow the mouthpiece 30 to be rotated with respect to the body 12 of the spray head 10 to adjust the axial position of the deflector element with respect to the outlet region 42 of the flow passage in order to adjust the spray characteristics of the spray head.

A spray head 100 for a shower in accordance with a second embodiment of the present invention is illustrated in FIGS. 6 to 9. The spray head 100 of the second embodiment is essentially the same as that of the first embodiment, comprising a moulded plastic body 112 defining a handle portion 114 and a head portion 116, said body 112 having a flow passage extending therethrough, comprising a first section 118 extending through the handle portion 114 and a second section 120 extending from a distal end of the first section 118 to an outlet opening of the flow passage, the second section 120 extending substantially perpendicular to the first section 118.

As with the first embodiment, a mouthpiece 130 is mounted within the outlet opening of the body 112 via a threaded connection, the mouthpiece 130 comprising a cylindrical member having a male thread 128 formed around an outer surface thereof received within a female thread formed in the outlet opening 142 of the body 112 of the spray head 100.

Unlike the first embodiment, the mouthpiece 130 of the spray head 100 of the second embodiment does not have a peripheral region in the shape of a shower head rose, while the body 112 of the spray head 100 is much more compact, having a small head portion at a distal end of the handle portion thereof.

As with the first embodiment, a deflector element 134 is mounted within the mouthpiece 130, the head 136 of the deflector element 134 being mounted within a through channel of the mouthpiece 130, defined by an annular wall region 132 of the mouthpiece 130, via radially extending legs 140, ensuring centralisation of the deflector element within the mouthpiece and flow passage. A stem 138 of the deflector element extends inwardly from the head 136 to extend into an end region of the flow passage of the body 112 of the spray head 100. The outlet opening 142 of the flow passage defines a bowl shaped region directly upstream of the head 136 of the deflector element 134. As shown in FIG. 9, the wall 132 of the mouthpiece defines a narrowed neck region adjacent the head 136 of the deflector element 134.

The spray head 100 of the second embodiment does not have the manual user adjustment feature of that of the first embodiment. Instead the distance between the head 136 of the deflector element 134 and the bowl shaped outlet opening 142 of the flow passage of the body 112 of the spray head 100 may be set by the dimensions of the mouthpiece 130 and/or the degree to which the mouthpiece is screwed into the body of the spray head and is thus set or calibrated during assembly of the spray head 100. It is envisaged that replacement mouthpiece components may be provided to provide differing spray characteristics, each replacement mouthpiece being adapted to provide a difference axial distance between the head 136 of the mouthpiece 130 and the bowl shaped outlet opening 142 of the body 112 of the spray head 100 by adjusting the position of the deflector element 134 with respect to the body of the mouthpiece 130. As shown in FIGS. 10 and 11, a tool 150 may be provided for adjusting and/or removing the mouthpiece 130, said tool 150 having a slotted head 152 adapted to engage the radially extending legs 140 of the mouthpiece.

The spray head 100 of the second embodiment provides a more compact and more aesthetically pleasing alternative to that of the first embodiment.

FIGS. 10 to 13 show a spray head in accordance with a third embodiment of the present invention. The spray head of FIGS. 10 to 13 is adapted for connection to a hose pipe for use, for example, for watering plants or washing purposes.

The spray head 200 comprises a moulded plastic body 212 having an axial flow passage 208 extending through the body from a male hose connector 210 at an inlet end and an outlet opening 214 at an opposite discharge end.

A mouthpiece 230 is threadedly mounted on the discharge end of the body 212. The mouthpiece 230 comprises an outer wall portion 231 located over an end region of the body 212 of the spray head 200 and a cylindrical inner wall portion 232, the inner wall portion 232 and the outer surface of an end region of the body 212 of the spray head having cooperating threads formed thereon such that the mouthpiece 230 can be screwed onto the body of the spray head 200.

As with the previous two embodiments, a deflector element 234 is mounted within the mouthpiece 230, the head 236 of the deflector element 234 being mounted within a through channel of the mouthpiece 230, defined by the cylindrical inner wall portion 232 of the mouthpiece 230, via radially extending legs 240, ensuring centralisation of the deflector element within the mouthpiece and flow passage. A stem 238 of the deflector element 234 extends inwardly from the head 236 to extend into an end region of the flow passage of the body 212 of the spray head 200.

The outlet opening 214 of the flow passage 208 defines a bowl shaped region 242 directly upstream of the head 236 of the deflector element 234. As shown in FIGS. 12 and 13, the outlet opening 214 of the flow passage 208 defines an annular passage adjacent the head 236 of the deflector element 234, a stepped region 244 being defined between the bowl shaped region 242 and said annular passage.

The distance between the head 236 of the deflector element 234 and the bowl shaped region 242 of the flow passage 208 of the body 112 of the spray head can be adjusted by rotating the mouthpiece 230 with respect to the body 212, thus facilitating adjustment of the spray characteristics of the spray head 200. The outer surface of the outer wall portion 231 of the mouthpiece 230 is provided with ribs to facilitate rotation of the mouthpiece. Cooperating barbed stops are provided on the outer surface of the body 212 and the inner surface of the outer wall portion 231 of the mouthpiece 230 to limit the axial travel of the mouthpiece 230 with respect to the body 212.

As shown in FIGS. 14 to 16, the spray head 200 may be provided with a flow control valve 330 for controlling the flow of water through the flow passage of the body. In the embodiment shown, the flow control valve 330 comprises a rotary valve comprising a cylindrical plug 332 having a through bore 334 that can be brought into and out of alignment with the flow passage 208 of the body 212 by rotation through 90° via an operating handle 336, the plug 332 being rotatable between an open position, shown in FIG. 15, wherein the through bore 334 is aligned with the flow passage 208, and a closed position, shown in FIG. 16, wherein the through bore 334 is at 90° to the flow passage 208.

In an alternative embodiment, shown in FIGS. 17 to 19, the deflector element 434 may serve as a flow control valve, a distal end 435 of the stem 438 of the deflector element 434 cooperating with a tapered or narrowed neck region 409 of flow passage 408 to close the flow passage 408 when the mouthpiece 430 is fully screwed down onto the body 412 of the spray head 400, as shown in FIG. 19, such that the distal end 435 of the stem 438 of the deflector element 434 engages the neck region 409 of the flow passage 408.

A spray head 500 in accordance with a further embodiment of the present invention is illustrated in FIGS. 21 to 24.

This embodiment differs from the previous embodiments of the invention in that the deflector element 534 is mounted within the flow passage 508 of the body 512 of the spray head 500 by means of a plurality of equi-spaced legs or ribs 540 extending between the stem 538 of the deflector element 530 and the inner wall of the flow passage 508 of the body 512 of the spray head 500. As shown in FIG. 24, the legs or ribs 540 extend across an annular flow path 548 defined between the stem 538 of the deflector element 534 and the flow passage 508 of the body 512 of the spray head 500. As with the previous embodiments, the legs or ribs 540 ensure that the deflector element 534 is centrally mounted within the flow passage 508.

As with the previous embodiments, the head 536 of the deflector element 534 is located within a through channel of a mouthpiece 530 threadedly mounted on the discharge end of the body 512.

The outlet opening of the flow passage 508 of the body 512 of the spray head 500 defines a bowl shaped region 542 directly upstream of the head 536 of the deflector element 534. As shown in FIGS. 22 and 23, a central through bore of the mouthpiece 530 defined a narrowed neck region 550 adjacent the head 536 of the deflector element 534, upstream of an outlet region of the mouthpiece 530.

The distance between the head 536 of the deflector element 534 and the outer edge of said narrowed neck region 550 of the mouthpiece 530 can be adjusted by rotating the mouthpiece 530 with respect to the body 512 of the spray head 500, thus facilitating adjustment of the spray characteristics of the spray head 500.

The invention is not limited to the embodiment(s) described herein but can be amended or modified without departing from the scope of the present invention.

1. A spray head comprising a body having a flow passage therethrough, said flow passage having an outlet opening, a mouthpiece being mounted on said body, said mouthpiece having a wall portion defining a through channel communicating with said flow passage, a deflector element being provided comprising a head portion located centrally within said through channel of the mouthpiece to define a flow path between said head portion of the deflector element and said wall portion of the mouthpiece and an elongate stem extending inwardly from the head portion into said flow passage of the body to define a flow restriction within said flow passage, characterised in that the deflector element is supported within the through channel of the mouthpiece by at least one elongate rib or leg extending between said wall portion of the mouthpiece or a wall portion of the flow passage and a portion of the deflector element.

2. The spray head of claim 1, wherein said flow path comprises a substantially annular passageway between said wall portion of the mouthpiece and said head portion of the deflector element.

3. The spray head of claim 1, wherein the deflector element is supported by a plurality of radially extending ribs or legs.

4. The spray head of claim 3, wherein said ribs or legs are equi-spaced around the deflector element.

5. The spray head of claim 4, wherein the deflector element is supported by four equally spaced ribs or legs.

6. The spray head of claim 1, wherein said at least one elongate rib or leg extends between the wall portion of the mouthpiece and the head portion of the deflector element.

7. The spray head of claim 1, wherein said at least one elongate rib or leg extends between a wall portion of the flow passage and the elongate stem of the deflector element.

8. The spray head of claim 1, wherein said deflector element is integrally formed with said mouthpiece.

9. The spray head of claim 1, wherein said deflector element comprises a rotationally symmetrical body.

10. The spray head of claim 9, wherein an underside of the head portion defines a dish shaped surface facing said outlet opening of the flow passage.

11. The spray head of claim 1, wherein said outlet opening of the flow passage comprises an enlarged region immediately upstream of said head portion of the deflector element.

12. The spray head of claim 11, wherein the walls of the flow passage defining said enlarged region comprise a conical surface converging axially outwardly and terminating in a substantially cylindrical surface to define a bowl shaped region of said flow passage.

13. The spray head of claim 12, wherein said head portion of the deflector element is located immediately upstream of said bowl shaped region.

14. The spray head of claim 1, wherein the body of the spray head and the mouthpiece are provided with a threaded connection to releasably secure the mouthpiece to said body.

15. The spray head of claim 14, wherein said threaded connection between said mouthpiece and the body of the spray head is adapted to enable the axial distance between the head portion of the deflector element and said enlarged region of the flow passage of the body of the spray head to be adjusted.

16. The spray head of claim 15, wherein at least a portion of the stem of the deflector element and/or a cooperating region of the flow passage is tapered or otherwise shaped such that the flow restriction defined by said tapered region within the flow passage can be adjusted by adjusting the axial position of the stem within said flow passage.

17. The spray head of claim 16, wherein said stem of the deflector element is adapted to close the flow passage of the body by virtue of said adjustment of the axial position of the stem within the flow passage.

18. The spray head of claim 1, wherein a substantially annular outlet passage is provided downstream of said head portion of the deflector element.

19. The spray head of claim 18, wherein said outlet passage is defined within said mouthpiece.

20. The spray head of claim 19, wherein said outlet passage is defined by a substantially cylindrical outer portion of the mouthpiece.

21. The spray head of claim 1, wherein an insert is mounted on the body within the outlet opening, said insert comprising said mouthpiece, said insert incorporating said deflector element.
